(19) United States
(12) Patent Application Publication
(10) Pub. No.: US 2005/0257426 A1
(43) Pub. Date: Nov. 24, 2005

(54) Hydrogen production method

(76) Inventors: Hajime Kabashima, Saitama (JP); Jun Iwamoto, Saitama (JP); Masaru Oku, Saitama (JP)

Correspondence Address: ARENT FOX PLLC, Suite 400, 1050 Connecticut Avenue, N.W., Washington, DC, 20036-5339, US

(21) Appl. No.: 11/124,371

(22) Filed: May 9, 2005

(30) Foreign Application Priority Data
May 11, 2004 (JP) 2004-140957

(51) Int. Cl. C01B 3/24

(52) U.S. Cl. 48/198.7; 48/198.1

(57) ABSTRACT

The present invention provides a method of efficiently reforming an automotive fuel and producing hydrogen continuously at high selectivity and high yield even under conditions of low A/F ratio in the reforming of the automotive fuel using autothermal reforming, and the like., can efficiently reform and produce hydrogen even under conditions of low A/F ratio by using oxygen-enriched air and water vapor in reforming reactions of an automotive fuel and adjusting the molar ratio of the water vapor with respect to the carbon atoms in the automotive fuel to reform the automotive fuel.

### CROSS-REFERENCE TO RELATED APPLICATIONS

This application is based upon and claims the benefit of priority from the prior Japanese Patent Application No. 2004-140957 filed on May 11 in 2004, the entire contents of which is incorporated herein by reference.

### FIELD OF THE INVENTION

The present invention concerns a method of efficiently reforming gasoline, diesel fuel, or other automotive fuel to produce hydrogen at high yield.

### BACKGROUND OF THE INVENTION

Hydrogen energy is a clean form of energy and future use of hydrogen as an energy source for fuel cells, internal combustion engines, etc., is anticipated. In regard to internal combustion engines, research on hydrogen engines, hydrogen-added engines, NOx removal using hydrogen as a reducing agent, etc., are being carried out. Also in regard to the supplying of hydrogen as a fuel of fuel cells, active research and development are being carried out on methods of producing hydrogen by fuel reforming. In particular for onboard fuel reforming, partial oxidation reforming and autothermal reforming, in which partial oxidation reforming and water-vapor reforming are combined, are regarded as important methods from the standpoint of making a hydrogen production device compact and lightweight, instantaneous startup, and load response characteristics (see Non-Patent Document 1 “Journal of the Japan Institute of Energy,” Vol. 80, No. 2, 2001, pp. 59-68, Non-Patent Document 2 “Journal of the Japan Institute of Energy,” Vol. 80, No. 2, 2001, pp. 76-80, and Non-Patent Document 3 “Journal of Chemical Engineering of Japan,” Vol. 65, No. 10, 2001, pp. 19-23.)

From the standpoints of hydrogen yield (energy efficiency), autothermal reforming is more preferable than partial oxidation reforming.

For example, when autothermal reforming of diesel fuel is to be carried out at a reaction temperature of 800° C. under the presence of a supported Rh catalyst, the weight ratio of air to fuel (referred to hereinafter as “A/F ratio”) must be set in the range of 5 to 7 and preferably set to 6 in order to obtain an adequate hydrogen yield. This is because, though from the standpoints of making a hydrogen production device compact and lightweight, instantaneous startup, and load response characteristics, reforming reactions are preferably carried out at an A/F ratio that is as low as possible, when autothermal reforming reactions are carried out at an A/F ratio of no more than 5, the reaction rates of the water-vapor reforming reactions become low and an adequate hydrogen yield cannot be obtained.

The establishment of a method of producing hydrogen efficiently even under conditions of low A/F ratio in the reforming of an automotive fuel using autothermal reforming, etc., not only enables hydrogen to be provided readily for a fuel cell or internal combustion engine but is also beneficial for contributions towards efficient use of hydrocarbon resources.

### SUMMARY OF THE INVENTION

The present invention has been made in view of the above issues and an object thereof is to provide a method of efficiently reforming an automotive fuel and producing hydrogen continuously at high selectivity and high yield even under conditions of low A/F ratio in the reforming of the automotive fuel using autothermal reforming, and the like.

As a result of engaging in diligent research towards achieving the above object, present inventors found that by using oxygen-enriched air and water vapor in reforming reactions of an automotive fuel and adjusting the molar ratio of the water vapor with respect to the carbon atoms in the automotive fuel, the automotive fuel can be reformed efficiently and hydrogen can be produced efficiently even under conditions of low A/F ratio. More specifically, the present invention provides the following.

(1) A hydrogen production method for producing hydrogen wherein hydrogen is produced by reforming an automotive fuel, the automotive fuel is subject to reforming reactions under the presence of oxygen-enriched air and water vapor to produce hydrogen.

(2) The hydrogen production method according to (1), wherein hydrogen is produced by carrying out the reforming reactions upon adjusting the molar ratio of the water vapor with respect to the carbon atoms in the automotive fuel.

(3) The hydrogen production method according to (1) or (2), wherein the molar ratio of the water vapor with respect to the carbon atoms in the automotive fuel is set to no less than 0.1 and no more than 7.0.

(4) The hydrogen production method according to any one of (1) to (3), wherein the reforming reactions are autothermal reforming reactions.

(5) The hydrogen production method according to any one of (1) to (4), wherein the reforming reactions are carried out continuously.

(6) A method of controlling the efficiency of reforming reactions of an automotive fuel, wherein the reforming reactions, carried out under the presence of oxygen-enriched air and water vapor, controlling the efficiency of the reforming reactions by adjusting the molar ratio of the water vapor with respect to the carbon atoms in the automotive fuel.

Autothermal reforming is a reforming method in which partial oxidation reforming reactions, indicated by Chemical Reaction Equation 1, and water-vapor reforming reactions, indicated by Chemical Reaction Equation 3, are combined. Here, the partial oxidation reforming reactions are reactions in which hydrocarbons are reformed by oxygen to produce hydrogen and carbon monoxide, and the water-vapor reforming reactions are reactions in which hydrocarbons are reformed by water vapor to produce hydrogen and carbon monoxide. Thus if the amount of coexisting oxygen exceeds a certain amount, complete oxidation reactions, progress as indicated by Chemical Reaction Equation 2, and hydrogen cannot be obtained.

[Chemical Equations 1]
C₁₆H₃₄+8O₂→16CO+17H₂ (Chemical Reaction Equation 1)
C₁₆H₃₄+24.5O₂→16CO₂+17H₂O (Chemical Reaction Equation 2)
C₁₆H₃₄+16H₂O→16CO+25H₂ (Chemical Reaction Equation 3)

In autothermal reforming, oxygen and water vapor act as oxidizing agents. Specifically, the oxygen in air promotes the partial oxidation reactions and the water-vapor reforming reactions and the water vapor promotes the water-vapor reforming reactions. Thus in autothermal reforming of an automotive fuel, the control of the amounts of oxygen and water vapor existing in the reforming reactions is extremely important.

The present invention enables efficient production of hydrogen by the control of the oxygen amount and the water vapor amount in autothermal reforming of automotive fuel, and with the present invention, the reforming reactions are carried out under the presence of oxygen-enriched air and water vapor and by adjusting the molar ratio of the water vapor with respect to the carbon atoms in the automotive fuel. More specifically, the partial oxidation reactions are promoted by increasing the oxygen amount within a range in which the partial oxidation reactions occur and the water-vapor reforming reactions are promoted by setting the molar ratio of the water vapor with respect to the carbon atoms in the automotive fuel within a predetermined range. Thus with the present invention, even under conditions of low A/F ratio, under which the reaction rates of water-vapor reforming reactions become small in conventional arts, the partial oxidation reactions and the water-vapor reforming reactions progress efficiently and a high hydrogen yield can be obtained.

By the present invention, even under conditions of low A/F ratio, an automotive fuel can be modified by autothermal reforming and hydrogen can be produced efficiently, and the following effects are provided. Firstly, since the spatial velocity can be made small, the reformer can be made compact. Secondly, since a small amount of catalyst suffices and the amount of precious metals used can be reduced, low cost can be realized. Thirdly, the startup time for the reforming reactions can be shortened in comparison to conventional methods and the energy consumption in the process of starting up the reforming reactions can be reduced. Fourthly, the operability and load response characteristics are improved in comparison with conventional methods.

### BRIEF DESCRIPTION OF THE DRAWINGS

FIG. 1 is a schematic block diagram of a representative, continuous-type hydrogen production device used in the present invention.

FIG. 2 is a diagram indicating the relationship between the [water vapor/carbon] molar ratio and the hydrogen yield in Example 1 and Comparative Example 1.

### DETAILED DESCRIPTION OF THE PREFERRED EMBODIMENT

Hereinafter, embodiments of the present invention shall be described referring to drawings.

[Raw Materials]

Since the present invention provides a hydrogen production method that makes use of reforming reactions of an automotive fuel, the main raw material used in the present invention is automotive fuel. Gasoline, diesel fuel, natural gas, propane gas, alcohols, bio-diesel, and other hydrocarbons can be cited as examples of automotive fuel. These hydrocarbons include alkanes, alkenes, alkynes, aromatic compounds, and the like.

As reforming agents in the reforming of automotive fuel, air, oxygen-enriched air, oxygen, water vapor, etc., are used. For water vapor, in addition to pure water, rainwater, tap water, primary treated wastewater, etc., can be used. Also, a hydrogen production method related to the present invention is characterized in that the reforming reactions are carried out under the presence of oxygen-enriched air and oxygen serves a primary role as an oxidizing agent. Here, oxygen-enriched air refers to air that is rich in oxygen and specifically, the preferable oxygen concentration is within the range of no less than 25% and less than 100% as volume %. A more preferable oxygen concentration is within the range of 30% to 60%, and most preferably, the oxygen concentration is within the range of 35% to 45% and centered about approximately 40%. It is not preferable for the amount of oxygen introduced into the reaction system to become too high, since the hydrogen produced by the reforming reactions will then become oxidized and changed to water, thus degrading the energy efficiency and lowering the hydrogen gas yield.

Also, the automotive fuel reforming reactions in the present invention are carried out using a reforming catalyst. A generally-used reforming catalyst can be used and, for example, a Rh/Al₂0₃ reforming catalyst, etc., can be used. This Rh/Al₂0₃ reforming catalyst can be obtained by adding γ-Al₂0₃ to an aqueous solution of Rh and thereafter carrying out impregnation.

[Hydrogen Production Device]

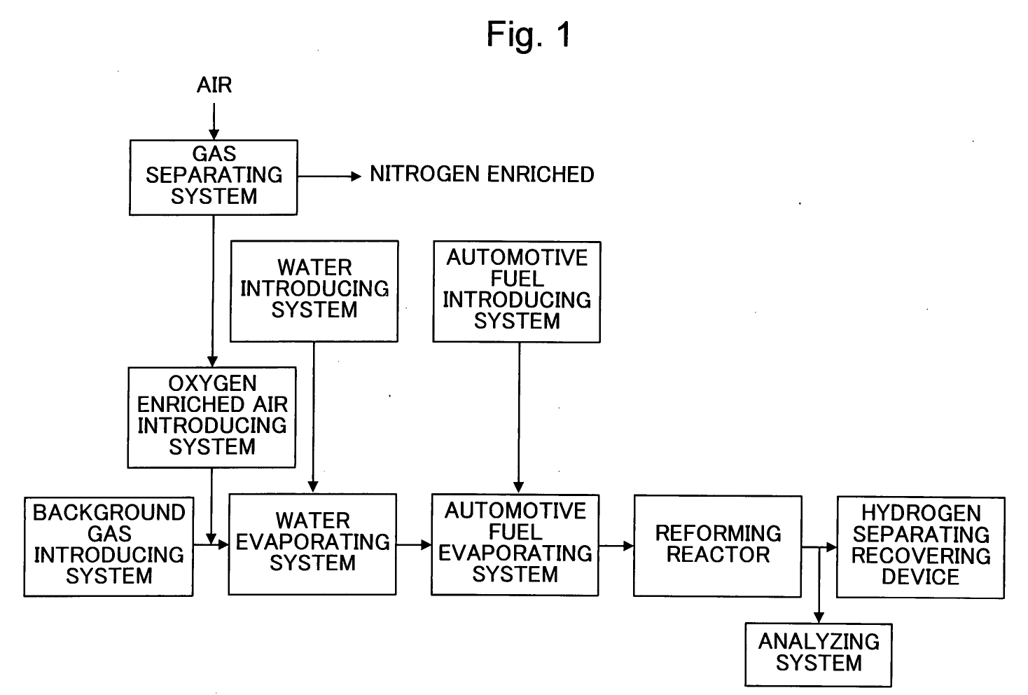

Since the present invention's hydrogen production method can be carried out in either a batch system or a continuous system, all conventionally known reforming reactors can be used and there are no restrictions in particular. For example, a fixed bed flow reactor, a batch reactor, etc., can be used. With the present invention, since even in the case where reaction gases are supplied continuously to a reforming reactor, the reforming reaction by the catalyst can be carried out in a stable manner and the hydrogen yield does not drop much, a continuous system is preferably employed. FIG. 1 shows a schematic block diagram of a representative, continuous-type hydrogen production device to be used in the present invention. This hydrogen production device has, as its principal components, a background gas introduction system that introduces a background gas, a gas separation system that is used to obtain oxygen-enriched air from air, an oxygen-enriched air introduction system that introduces the oxygen-enriched air obtained by the gas separation system, a water introduction system that introduces water, a water vaporization system that vaporizes the water, an automotive fuel introduction system that introduces the automotive fuel, an automotive fuel vaporization system that vaporizes the automotive fuel, a reforming reactor that reforms the automotive fuel, a hydrogen separation and recovery device that separates and recovers the hydrogen obtained by the reforming reactions, and an analysis system that analyzes the product gas obtained by the reforming reactions. As a gas separation film to be used in the gas separation system, all such films that are conventionally known can be used and there are no restrictions in particular. Polyimide hollow fibers, flat polydimethylsiloxane membranes, etc., can be cited as examples.

Specifically, after mixing the automotive fuel with the background gas, the oxygen-enriched air is mixed in, and the mixture is introduced into the reforming reactor via a stop valve, flow control valve, etc., and by being controlled by a gas flow rate control system equipped with a flow meter. The mixed gas that is introduced is reformed by the reforming reactor and a hydrogen-containing gas is thereby produced. The components of the produced hydrogen-containing gas are analyzed by the analysis system, which is equipped with a gas chromatograph, etc. The produced gas is then sent to the hydrogen recovery device and the hydrogen, which is intended to be produced, is recovered. Gases besides hydrogen are treated by a waste gas treatment system.

[Reforming Reactions]

With the reforming reactions in the present invention, the automotive fuel is reformed using the reforming catalyst under the presence of oxygen-enriched air and water vapor, and though the automotive fuel may be introduced directly into the reforming reactor to carry out the reforming reactions, it is preferable to introduce the automotive fuel into the reforming reactor upon vaporization in air or other background gas. Though the A/F ratio, which is the weight ratio of air to fuel, can be adjusted to be made suitable by adjusting the gas flow rates, it is not preferable for the oxygen concentration in the background gas to become too high since the hydrogen produced by the reforming reactions will then become oxidized and changed to water, thereby lowering the hydrogen gas yield.

In order to promote the partial oxidation reactions, the concentration of the automotive fuel is increased and the gas flow rates are increased within the oxygen concentration range in which the partial oxidation reactions occur. Preferably, the A/F ratio is within the range of 1 to 20, more preferably, the A/F ratio is within the range of 2 to 10, and most preferably, the A/F ratio is within the range of 4 to 8 and centered about an A/F ratio of approximately 6. Though conventionally, there was the problem that the reaction rates of the water-vapor reforming reactions become low under such conditions in which the A/F ratio is no more than 5, with the present invention, this problem is avoided by adjusting the molar ratio of water vapor with respect to the carbon atoms in the automotive fuel. That is, with the present invention, the partial oxidation reactions and the water-vapor reforming reactions progress efficiently and a high hydrogen yield can be obtained. Though the reaction pressure is not restricted in particular, it is preferably at a normal pressure of 1 atmosphere.

Also, the reforming reaction in the present invention can be carried out in a reaction temperature range of approximately 500° C. to 900° C., and the hydrogen concentration can be adjusted by means of the vapor pressure of the reforming products. Also with the method of producing hydrogen from automotive fuel in the present invention, CO, CO₂, and hydrocarbons are produced in addition to hydrogen.

Though the present invention shall now be described in detail by way of an example, the present invention is not limited thereto.

### EXAMPLE 1

Reforming of a diesel fuel by autothermal reforming reactions was carried out under the presence of oxygen-enriched air with an oxygen concentration of 40%. With the reaction temperature, LHSV, A/F ratio, and background gas flow rate being fixed at predetermined values, the [water vapor/carbon] molar ratio was varied in the range of 0 to 7. A continuous type hydrogen production device was used as the hydrogen production device and an Rh/Al₂0₃ reforming catalyst was used as the catalyst.

[Preparation of the Rh/Al₂0₃ Reforming Catalyst]

[Preparation of γ-Al₂0₃]

Approximately 100 g of prepared γ-Al₂0₃ (AKP-G30LA, made by Sumitomo Chemical Co., Ltd.) were suspended in 200 mL of ultrapure water in a 500 mL beaker. A Teflon (registered trade name) stirrer piece was placed in the suspension and stirring was carried out quietly for a few minutes under room temperature using a magnetic stirrer with hot plate. After stirring, the water was removed, and the above operations were repeated three times. The γ-Al₂0₃ that was subject to three repetitions of the above operations was covered to avoid the entry of debris and water was distilled off by vacuum drying at 80° C. overnight. After drying, the γ-Al₂0₃ was transferred to a preservation container and preserved in a desiccator until use.

[Preparation of Rh/Al₂0₃ (Impregnation Method)]

25 g of the dried γ-Al₂0₃ were weighed out. Rhodium nitrate [Rh(NO₃)₃] of an amount such that the weight percentage of rhodium metal with respect to the γ-Al₂0₃ will be 2% was then weighed out.

[Supporting of Catalyst]

The rhodium nitrate and 350 mL of ultrapure water were placed in and heated while stirring in a 500 mL three-necked flask, and the γ-Al₂0₃, which was put in the form of a solution of 60° C., was added slowly at small amounts at a time into the 500 mL three-necked flask. After adding the aqueous γ-Al₂0₃ solution, stirring at 60° C. was carried out for 1 hour. The water was distilled out from the slurry, which was then dried by placing in an oven set at 100° C. for 12 hours. The dried catalyst was then baked by placing in an electric furnace set at 400° C. for 4 hours.

[Reforming Reaction Conditions]

Since the LHSV (liquid hourly space velocity=spatial velocity of the fuel per hour) with respect to the catalyst is preferably within the range of 0.5 h⁻¹ to 20 h⁻¹, the reforming reaction was carried out at an LHSV of 2.3. Air was used as the background gas, and since the A/F weight ratio of the air (Air) with respect to the diesel fuel (Fuel) is preferably in the range of 2 to 20, the A/F ratio was set to 4. Also, since the reforming reaction is preferably carried out in the range of 500° C. to 1000° C., the reaction temperature was set to 800° C. Quantitative analysis was carried out using a GC (GC-390B, Unipack S, made by GL Science) equipped with an FID (hydrogen flame ionization detector) as the detector. Quantitative analysis of hydrogen was carried out using a GC (GC-390B, MS-5A, made by Shimadzu) equipped with a TCD (thermoconductivity detector).

### COMPARATIVE EXAMPLE 1

As Comparative Example 1, reforming of the diesel fuel by autothermal reforming reactions was carried out using ordinary air with an oxygen concentration of 21%. Besides the oxygen concentration of the air used being lower than that of Example 1, operations were carried out in the same manner as Example 1 in regard to the hydrogen production device used, the catalyst, the reforming reaction conditions, etc.

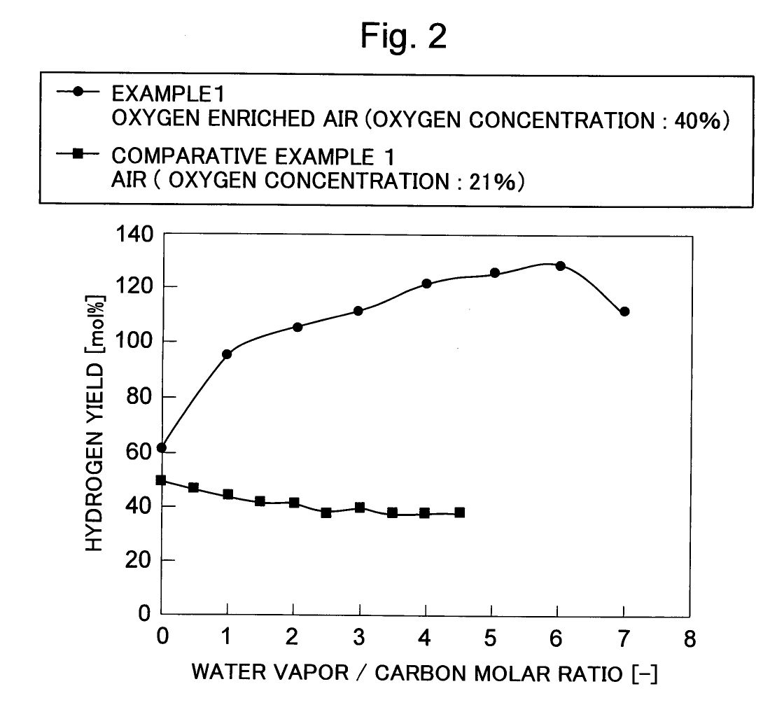

The results obtained in Example 1 and Comparative Example 1 are shown in FIG. 2. FIG. 2 shows the results of examining the effects of the [water vapor/carbon] molar ratio on the hydrogen yield. The present reforming reactions are autothermal reforming reactions of diesel fuel, and according to the results of Example 1, the maximum hydrogen yield was approximately 130%. Here, hydrogen yield refers to the recovered amount of hydrogen (mol %) with respect to the amount of hydrogen (mol %) contained in the fuel as indicated by Equation 1.
Hydrogen yield (mol %)=(Recovered hydrogen amount (mol %)/Amount of hydrogen contained in fuel (mol %))×100 [Equation 1]

A comparison of Example 1 and Comparative Example 1 shows that even when water vapor is not present and the [water vapor/carbon] molar ratio is 0, that is, even when just partial oxidation reactions and complete oxidation reactions occur, a 10% higher hydrogen yield was exhibited by Example 1. Also, as water vapor was added and the [water vapor/carbon] molar ratio was increased, the hydrogen yield decreased with Comparative Example 1. This is considered to be due to the lowering of the contact efficiency of the diesel fuel and the catalyst due to the added water vapor, and it is considered that with Comparative Example 1, water vapor reforming reactions do not progress even when water vapor is added. Meanwhile, with Example 1, as water vapor was added and the [water vapor/carbon] molar ratio was increased, the hydrogen yield increased. The maximum hydrogen yield of approximately 130% was exhibited at a [water vapor/carbon] molar ratio of 6 and the hydrogen yield decreased at a [water vapor/carbon] molar ratio of 7. Since the hydrogen yield increased with the water vapor amount and since the hydrogen yield exceeded 100%, it is considered that water vapor reforming reactions progressed efficiently in Example 1. It was thus confirmed that in comparison to Comparative Example 1, autothermal reforming reactions progress and hydrogen can be produced efficiently even under conditions of low A/F with Example 1.

1. A hydrogen production method for producing hydrogen, wherein hydrogen is produced by reforming an automotive fuel, the automotive fuel is subject to reforming reactions under the presence of oxygen-enriched air and water vapor to produce hydrogen.

2. The hydrogen production method according to claim 1, wherein hydrogen is produced by carrying out the reforming reactions upon adjusting the molar ratio of the water vapor with respect to the carbon atoms in the automotive fuel.

3. The hydrogen production method according to claim 1, wherein the molar ratio of the water vapor with respect to the carbon atoms in the automotive fuel is set to no less than 0.1 and no more than 7.0.

4. The hydrogen production method according to claim 2, wherein the molar ratio of the water vapor with respect to the carbon atoms in the automotive fuel is set to no less than 0.1 and no more than 7.0.

5. The hydrogen production method according to claim 1, wherein the reforming reactions are autothermal reforming reactions.

6. The hydrogen production method according to claim 2, wherein the reforming reactions are autothermal reforming reactions.

7 The hydrogen production method according to claim 3, wherein the reforming reactions are autothermal reforming reactions.

8. The hydrogen production method according to claim 4, wherein the reforming reactions are autothermal reforming reactions.

9. The hydrogen production method according to claim 1, wherein the reforming reactions are carried out continuously.

10. The hydrogen production method according to claim 2, wherein the reforming reactions are carried out continuously.

11. The hydrogen production method according to claim 3, wherein the reforming reactions are carried out continuously.

12. The hydrogen production method according to claim 4, wherein the reforming reactions are carried out continuously.

13. The hydrogen production method according to claim 5, wherein the reforming reactions are carried out continuously.

14. The hydrogen production method according to claim 6, wherein the reforming reactions are carried out continuously.

15. The hydrogen production method according to claim 7, wherein the reforming reactions are carried out continuously.

16. The hydrogen production method according to claim 8, wherein the reforming reactions are carried out continuously.

17. A method of controlling the efficiency of reforming reactions of an automotive fuel, wherein
the reforming reactions, carried out under the presence of oxygen-enriched air and water vapor, controlling the efficiency of the reforming reactions by adjusting the molar ratio of the water vapor with respect to the carbon atoms in the automotive fuel.
